(19) United States
(12) Patent Application Publication
(10) Pub. No.: US 2015/0146726 A1
(43) Pub. Date: May 28, 2015

(54) HYBRID DATA PLANE FORWARDING

(71) Applicant: Yuankui Zhao, Shanghai (CN)

(72) Inventor: Yuankui Zhao, Shanghai (CN)

(73) Assignee: QUALCOMM INCORPORATED, San Diego, CA (US)

(21) Appl. No.: 14/397,816

(22) PCT Filed: May 30, 2012
(86) PCT No.: PCT/CN2012/076277

§ 371 Date: Oct. 29, 2014

(51) Int. Cl. H04L 12/741; H04L 12/935

(52) U.S. Cl. CPC H04L 45/74; H04L 49/30
USPC 370/392

(57) ABSTRACT

A hybrid switching device is disclosed that allow packets transmitted according to different communication protocols to be forwarded in a seamless manner using the same resources of a universal data plane, thereby alleviating the need to employ separate forwarding engines for different types of data planes and/or communication protocols. In operation, if the destination address of a packet received by the switching device is not stored therein, the switching device determines the protocol type of the originating port and, in response thereto, selects an appropriate packet flooding operation to ensure that the packet reaches its destination without creating unnecessary data loops within the switching device.

### TECHNICAL FIELD

The present embodiments relate generally to computer networks, and specifically to forwarding packets through switching devices associated with computer networks.

### BACKGROUND OF RELATED ART

A computer network includes a plurality of interconnected devices that can exchange data over various communication paths or routes. In packet-based networks (e.g., the Internet, local area networks (LANs), wireless LANs (WLANs), and Ethernet networks), network devices exchange data by dividing the data into smaller units called packets, which are then individually routed across the network by a number of network routers and/or switching devices. For example, when a data file (e.g., an email, video, document, and so on) is sent from a source device to a destination device on a network, the file is divided into smaller data packets for more efficient transmission. The individual packets for a given data file may travel different routes across one or more networks, with each packet containing both data and routing information. As such, a packet can be described as having a payload that contains the data, and a header that contains the routing information.

A router is a device that determines the next network segment to which a packet is to be forwarded towards its destination. Routers, which can be positioned at points within a network and at points between networks, typically maintain tables of the available routes and their conditions to determine the best route between a source device and a destination device for a given packet. Indeed, a packet may travel through a number of network points having routers before arriving at its destination.

When a data packet arrives at the input of a router, several lookups are typically performed to determine the subsequent handling of the packet, as illustrated in FIG. 1. The lookups may include where to send the packet next (Next Hop), the quality of service requirement (QoS), the Ethernet port address, and so on. For example, consider a packet arriving at Router-A. Router-A determines whether the packet is destined for local servers connected directly to Router-A via its associated Ethernet switch, or whether the packet should go to the next router (Router-B) towards its destination. Similarly, when a packet arrives at the input of the Ethernet switch of FIG. 1, one or more lookups are typically performed to determine which port of the switching device the packet should be forwarded to (e.g., to Server-1 on a first port (P1) of the Ethernet switch or to Server-2 on a second port (P2) of the Ethernet switch).

More specifically, when an Ethernet switch receives a packet, the destination address of the packet is extracted and compared with forwarding entries stored in an associated forwarding information base (FIB). Each of the forwarding entries typically includes source information, destination information, and other routing information. If there is a match between the packet's destination address and a forwarding entry stored in the FIB, then the switching device forwards the packet to the output port indicated by the matching entry in the FIB. Conversely, if there is not a match (e.g., the packet's destination address is not stored in the FIB), then the switch typically floods the packet to all active physical ports except the port from which the packet was received. For example, if a packet is received by the Ethernet switch from Server-1 via port P1 and the packet's destination address is not stored in the switch's FIB, then the Ethernet switch floods the packet to ports P2 and P3 but not to port P1 because the packet originated from port P1. In this manner, the switch ensures that the destination device receives the packet regardless of the destination's location within the network while also preventing unnecessary data loops that may be created by flooding the packet back to its source (e.g., the switch assumes that the packet is not to be sent back to the same port from which it was received).

With the increasing popularity of wireless networks, many network switching devices are now equipped with multiple types of data planes and associated interfaces so that the same switching device can handle multiple types of communications. For example, hybrid networks capable of handling both Ethernet communications and Wi-Fi communications may employ hybrid network switching devices that include an Ethernet data plane and a WLAN data plane, where the Ethernet data plane interfaces with the switch's Ethernet ports and handles forwarding of Ethernet packets, and the WLAN data plane interfaces with the switch's Wi-Fi ports and handles forwarding of Wi-Fi packets. Unfortunately, traditional Ethernet and WLAN data planes operate according to different standards or protocols, and are typically operated by different controllers and/or software modules that may not work together in a seamless fashion. As a result, flooding operations performed in accordance with Ethernet protocols may not be successful for WLAN forwarding operations in hybrid switching devices having such “two switch” architectures.

More specifically, although flooding operations that avoid data loops are advantageous when forwarding Ethernet traffic through hybrid switching devices, such flooding operations may not be successful when forwarding WLAN traffic through such switching devices because a multitude of Wi-Fi devices may be associated with or “connected” to the same Wi-Fi port of the switch. For example, if a packet is to be sent from a first Wi-Fi device to a second Wi-Fi device through a switch and both the first and second Wi-Fi devices are connected to the same port of the switch, then flooding the packet to all ports except the originating port will fail to deliver the packet to its correct destination because the destination port is the same port as the originating port. As a result, additional software is typically needed to separately handle such WLAN forwarding operations, which not only strains processor resources but also undesirably segments packet handling functions of the Ethernet and WLAN data planes.

Thus, there is a need for a single hardware controller to provide a universal data plane that can handle both Ethernet and WLAN packet forwarding operations in an integrated and seamless manner.

### SUMMARY

A hybrid switching device and method of operation are disclosed that allow packets transmitted according to different communication protocols to be forwarded in a seamless manner using the same resources of a universal data plane, thereby alleviating the need to employ separate forwarding engines for different types of data planes and/or communication protocols. In accordance with the present embodiments, if the destination address of a packet received by the switching device is not stored in a forwarding table provided within the switching device, then the switching device determines the protocol type of the originating port and, in response thereto, selects an appropriate packet flooding operation to ensure that the packet reaches its destination without creating unnecessary data loops within the switching device. For some embodiments, if the originating port operates according to a wireless communication protocol (e.g., Wi-Fi or Bluetooth), then the switching device is to flood the data packet to all ports including the originating port, while if the originating port operates according to a wired communication protocol (e.g., Ethernet), then the switching device is to flood the data packet to all ports except the originating port.

More specifically, for some embodiments, the network switching device includes a Wi-Fi port coupled to a plurality of Wi-Fi client devices, includes a plurality of Ethernet ports each coupled to a corresponding one of a plurality of Ethernet client devices, includes a forwarding information base (FIB), and includes a forwarding engine. The FIB stores packet forwarding information and port/device protocol information. The forwarding engine, which is coupled to the Wi-Fi port, the Ethernet ports, and the FIB, is to receive a data packet from one of the client devices and to search the FIB for packet forwarding information. If there is no forwarding information for the packet stored in the FIB, then the forwarding engine is to identify the communication protocol/flooding behavior of the originating port. For some embodiments, the forwarding engine compares a source device ID and/or port number/port identifier extracted from the packet header with entries stored in the FIB to determine whether the data packet originated from the Wi-Fi port or from one of the Ethernet ports. Alternatively, the forwarding engine can extract that information from the packet header directly. If the originating port is one of the Ethernet ports, then the forwarding engine is to flood the data packet to all ports except for the originating port, thereby avoiding the creation of unnecessary data loops within the switching device. Conversely, if the originating port is the Wi-Fi port, then the forwarding engine is to flood the data packet to all ports including the originating port, thereby ensuring that the packet reaches its destination even if the source and destination devices are coupled to the same port of the switching device.

### BRIEF DESCRIPTION OF THE DRAWINGS

The present embodiments are illustrated by way of example and are not intended to be limited by the figures of the accompanying drawings, in which:

FIG. 1 depicts packet handling by a router and associated Ethernet switch in a network;

FIG. 2 is a block diagram of a hybrid switching device in accordance with some embodiments;

FIG. 3A shows an exemplary port forwarding table that can be implemented within the FIB of FIG. 2 in accordance with some embodiments;

FIG. 3B shows an exemplary protocol table that can be implemented within the FIB of FIG. 2 in accordance with some embodiments;

FIG. 3C shows an exemplary protocol table that can be implemented within the FIB of FIG. 2 in accordance with other embodiments; and

FIG. 4 is an illustrative flow chart depicting an exemplary operation for selectively forwarding packets through the switching device of FIG. 2 in accordance with some embodiments.

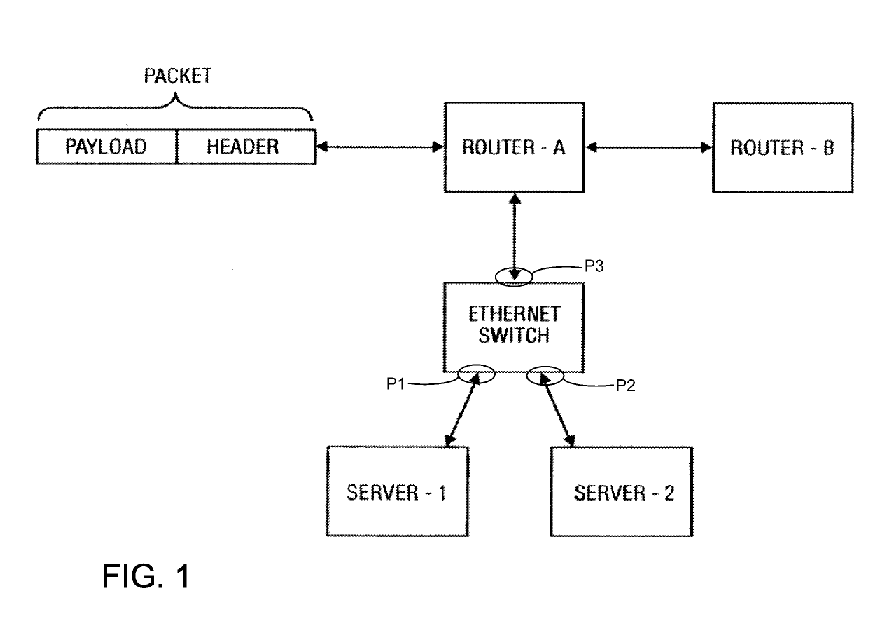

### DETAILED DESCRIPTION

A method and apparatus for forwarding packets transmitted according to different communication protocols in an integrated and seamless manner are disclosed. In the following description, for purposes of explanation, specific nomenclature is set forth to provide a thorough understanding of the present disclosure. However, it will be apparent to one skilled in the art that these specific details may not be required to practice the present embodiments. In other instances, well-known circuits and devices are shown in block diagram form to avoid obscuring the present embodiments unnecessarily. Additionally, the interconnections between circuit elements or blocks may be shown as buses or as single signal lines. Each of the buses may alternatively be a single signal line, and each of the single signal lines may alternatively be a bus. Further, the logic levels assigned to various signals in the description below are arbitrary, and therefore may be modified (e.g., reversed polarity) as desired. Accordingly, the present embodiments are not to be construed as limited to specific examples described herein but rather include within their scope all embodiments defined by the appended claims.

As used herein, the term Ethernet can include communications governed by the IEEE 802.3 family of standards, and the term WLAN can include communications governed by the IEEE 802.11 standards, Bluetooth, HiperLAN (a set of wireless standards, comparable to the IEEE 802.11 standards, used primarily in Europe), and other technologies having a relatively short radio propagation range.

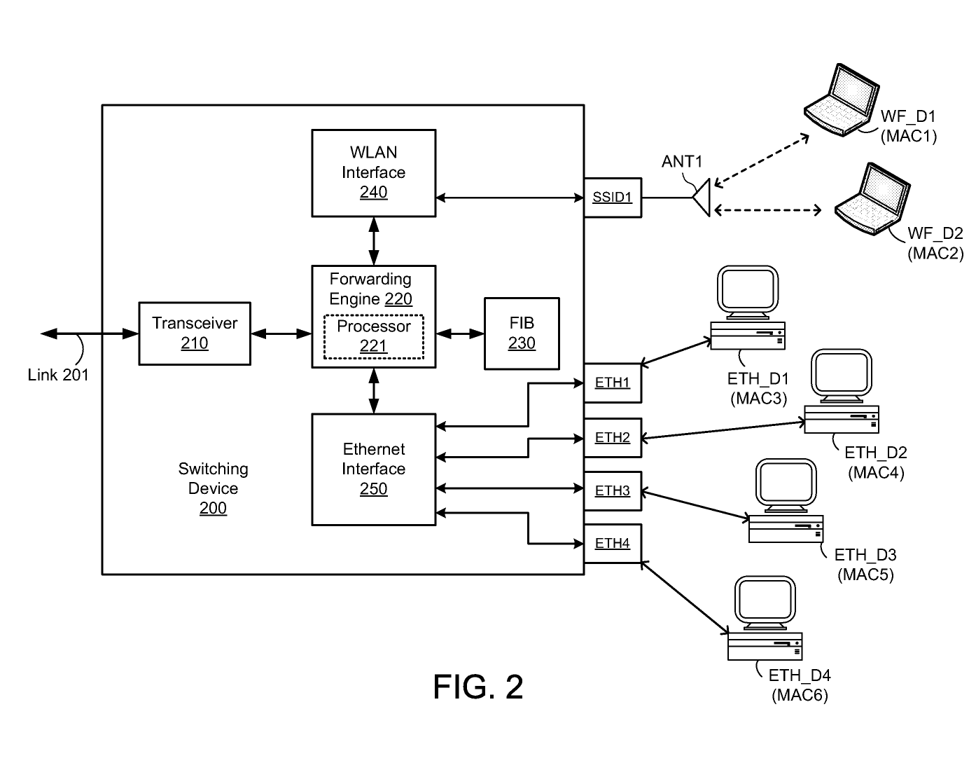

As mentioned above, although conventional flooding operations that avoid data loops are advantageous when forwarding Ethernet traffic through switching devices, such flooding operations may not be successful when forwarding WLAN traffic through switching devices. More specifically, conventional flooding operations that flood packets to all ports except for the originating port would not result in the delivery of a packet from a first Wi-Fi device to a second Wi-Fi device through a switching device in which both the first and second Wi-Fi devices are connected to the same port of the switching device (e.g., because the destination port would be the same port as the originating port, and therefore would be excluded from the flooding operation). The present embodiments solve this problem without using special software to separately handle WLAN traffic by providing a hybrid switching device that can detect the type of communication protocol associated with the originating port of a data packet, and in response thereto select an appropriate type of flooding operation, as described in more detail below with respect to FIGS. 2, 3A-3B, and 4.

FIG. 2 shows a hybrid network switching device 200 having a universal data plane that, in accordance with the present embodiments, can seamlessly handle data packets transmitted according to different communication protocols. Switching device 200 is shown to include a transceiver 210, a forwarding engine 220, a forwarding information base (FIB) 230, a WLAN interface 240, an Ethernet interface 250, a Wi-Fi port SSID1, and four Ethernet ports ETH1-ETH4. Note that switching device 200 is shown in FIG. 2 as including only one Wi-Fi port and four Ethernet ports for simplicity only; for actual embodiments, switching device 200 can include any suitable number of WLAN and/or Ethernet ports.

Wi-Fi port SSID1 is coupled to antenna ANT1, which in turn facilitates wireless communication between switching device 200 and the first and second W-Fi devices WF_D1 and WF_D2. Wi-Fi devices WF_D1 and WF_D2 can be any suitable mobile device (e.g., such as cell phone, laptop, tablet computer, wireless access point, PDA, and so on) capable of wirelessly communicating using Wi-Fi communication protocols, Bluetooth communication protocols, and/or other suitable wireless communication protocols. Although Wi-Fi port SSID1 is shown in FIG. 2 as being coupled to two Wi-Fi devices WF_D1 and WF_D2, for actual embodiments, Wi-Fi port SSID1 can be coupled to any suitable number of wireless devices via antenna ANT1. Also, for purposes of discussion herein, Wi-Fi port SSID1 and antenna ANT1 may be collectively referred to as the Wi-Fi port. Wi-Fi port SSID1 is controlled by WLAN interface 240, which may be any suitable WLAN interface and/or control module.

Ethernet ports ETH1-ETH4 are each coupled (e.g., via a wired medium such as an Ethernet cable, CAT-5 cable, or the like) to a corresponding one of four Ethernet devices ETH_D1-ETH_D4, respectively. Ethernet devices ETH_D1-ETH_D4 can be any suitable device (e.g., such a personal computer, server, router, switch, and so on) capable of communicating using Ethernet protocols or any other suitable packet-based wired communication protocol. Ethernet ports ETH1-ETH4 are controlled by Ethernet interface 250, which may be any suitable Ethernet interface and/or control module.

For some embodiments, the WLAN interface 240 can operate as a WLAN data plane that determines how Wi-Fi traffic is to be handled, and the Ethernet interface 250 can operate as an Ethernet data plane that determines how Ethernet traffic is to be handled. Together, the WLAN interface 240 and the Ethernet interface 250, which can be controlled by the forwarding engine 220, can operate as a universal hybrid data plane that implements both Ethernet and WLAN packet forwarding operations in a seamless manner while using the same hardware resources.

As depicted in FIG. 2, each of Wi-Fi devices WF_D1-WF_D2 and Ethernet devices ETH_D1-ETH_D4 is each assigned a unique MAC address (i.e., MAC1, MAC2, MAC3, MAC4, MAC5, and MAC6, respectively) that is programmed therein by, for example, the manufacturer. Each MAC address, which may be commonly referred to as the “burned-in address,” the organizationally unique identifier (OUI), or the BSSID, in one embodiment includes six bytes of data. The first 3 bytes of the MAC address may identify which organization manufactured the device, and may be assigned to such organizations by the Institute of Electrical and Electronic Engineers (IEEE). The second 3 bytes of the MAC address, which may be referred to as the network interface controller (NIC) specific bytes, may be used to uniquely identify the individual device.

Transceiver 210, which includes connections to an external link 201 (e.g., that in turn is connected to a suitable network such as the Internet, LAN, WAN, VLAN, and the like) and to forwarding engine 220, can include integrated transceiver circuits or can include separate transmitter and receiver circuits. More specifically, transceiver 210 can include any number of individual circuits or modules that perform signal transmission and/or reception functions according to various communication protocols to exchange data (e.g., packets) between switching device 200 and one or more other devices (not shown for simplicity) coupled to link 201.

Forwarding engine 220 is coupled to transceiver 210, FIB 230, WLAN interface 240, and Ethernet interface 250. Forwarding engine 220, which may include an optional processor 221, controls the packet forwarding operations of switching device 200. For example, when forwarding a data packet through switching device 200, forwarding engine 220 receives a data packet from either link 201, Wi-Fi port SSID1, or Ethernet ports ETH1-ETH4, stores the packet's payload in a suitable payload storage unit (not shown for simplicity), and then processes the packet's header information to determine which output port(s) to forward the packet to. Although not shown in FIG. 2 for simplicity, forwarding engine 220 can also include, or be coupled to, ingress circuitry and egress circuitry. The ingress circuitry is responsible for receiving packets from devices external to switching device 200, while the egress circuitry is responsible for outputting packets to devices external to switching device 200. For other embodiments, the ingress circuitry and/or egress circuitry can be associated with either the WLAN interface 240, the Ethernet interface 250, or both.

More specifically, the forwarding engine 220 is responsible for extracting address information and other routing information from the received packet's header, searching the FIB 230 for a matching entry, and then selectively forwarding the packet to its correct destination in response to the matching entry in the FIB 230. If there is not a matching entry stored in the FIB 230, then the forwarding engine 220 is to identify the originating port of the packet (e.g., which port the packet is received from), to determine which type of communication protocol the originating port operates according to (e.g., Wi-Fi or Ethernet), and to select an appropriate type of packet flooding operation in response to the determined communication protocol of the originating port. For some embodiments, the forwarding engine 220 can insert a protocol identifier into the packet's header (e.g., to indicate the type of communication protocol associated with the packet's source device and originating port). For such embodiments, the ingress circuitry can insert the protocol identifier into the packet's header. For some embodiments, the forwarding engine 220 can insert an indication about if flooding back to the origination port into the packet's header. For such embodiments, the ingress circuitry can insert the flooding indication into the packet's header.

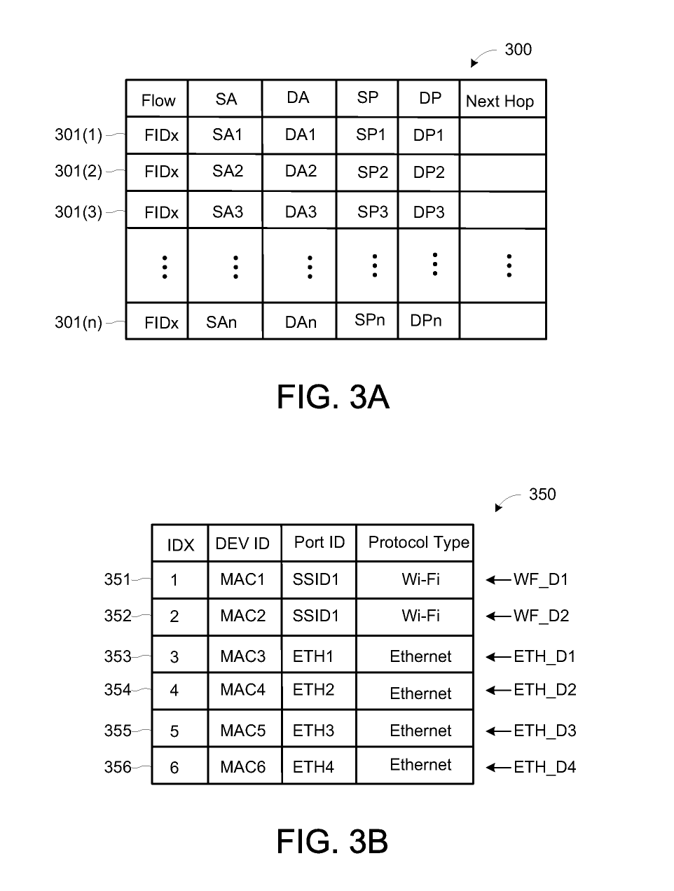

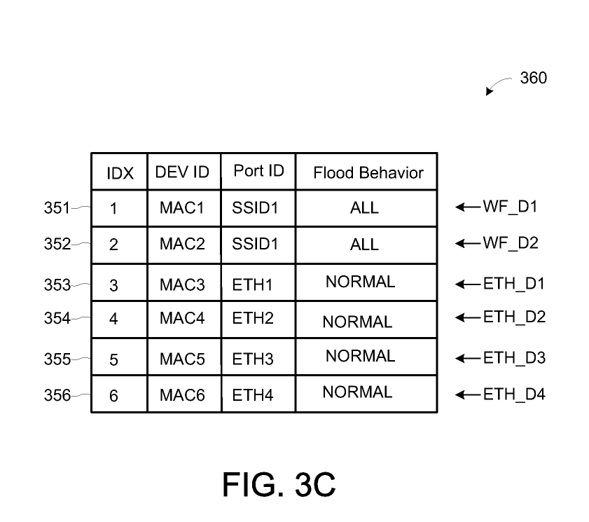

The FIB 230 is coupled to forwarding engine 220, and includes a look-up table that stores forwarding and/or routing information for packets transmitted through the switching device 200. More specifically, the FIB 230 includes a plurality of storage locations for storing a number of forwarding entries that can be used to forward packets received by the switching device 200 to its proper destination. For some embodiments, each forwarding entry in the FIB 230 may include data that identifies flow information, the source device, the source address, the source port, the destination port, the destination address, and the communication protocol type. For simplicity, packet forwarding look-up operations and communication protocol look-up operations are described separately below with respect to FIGS. 3A and 3B, respectively.

FIG. 3A shows an exemplary embodiment of a forwarding look-up table 300 that can be provided within the FIB 230 of FIG. 2. Look-up table 300 is shown to include a plurality of forwarding entries 301(1)-301(n), each of which stores forwarding information for packets destined to a particular destination device. Each of forwarding entries 301(1)-301(n) includes a flow ID that indicates which flow a particular packet belongs to, a source address (SA) indicating the address of the source device, a destination address (DA) indicating the address of the destination device, a source port (SP) indicating a source port of the switching device 200, a destination port (DP) indicating a destination port of the switching device 200, and next-hop information that indicates the next network segment the packet is to be forwarded to. Note that for packets to be routed between devices connected directly to switching device 200, the forwarding engine 220 may forward the packet to the indicated destination port of the switching device 200, while for packets to be routed to another router or switching device, the forwarding engine 220 may forward the packet to the transceiver 210 and onto link 201 for subsequent forwarding to the indicated next-hop address.

FIG. 3B shows an exemplary embodiment of a protocol look-up table 350 that can be provided within the FIB 230 of FIG. 2. Look-up table 350 is shown to include six protocol entries 351-356, each of which stores protocol information for a corresponding one of the external Wi-Fi and Ethernet client devices (e.g., WF_D1-WF_D2 and ETH_D1-ETH_D4) coupled to the ports of switching device 200. More specifically, each of entries 351-356 stores an index (IDX) value, a device ID (DEV ID) that stores the MAC address of the corresponding external client device, a port identifier (ID) identifying the port to which the corresponding external client device is coupled, and a protocol type indicating the type of communication protocol associated with the corresponding port. Thus, for example, entry 351 stores information indicating that Wi-Fi device WF_D1 has a MAC address of MAC1, that device WF_D1 is coupled to port SSID1, and that port SSID1 is a Wi-Fi port. Similarly, entry 352 stores information indicating that Wi-Fi device WF_D2 has a MAC address of MAC2, that device WF_D2 is coupled to port SSID1, and that port SSID1 is a Wi-Fi port. Entry 353 stores information indicating that Ethernet device ETH_D1 has a MAC address of MAC3, that device ETH_D1 is coupled to port ETH1, and that port ETH1 is an Ethernet port; entry 354 stores information indicating that Ethernet device ETH_D2 has a MAC address of MAC4, that device ETH_D2 is coupled to port ETH2, and that port ETH2 is an Ethernet port; entry 355 stores information indicating that Ethernet device ETH_D3 has a MAC address of MAC5, that device ETH_D3 is coupled to port ETH3, and that port ETH3 is an Ethernet port; and entry 356 stores information indicating that Ethernet device ETH_D4 has a MAC address of MACE, that device ETH_D4 is coupled to port ETH4, and that port ETH4 is an Ethernet port.

For some embodiments, the protocol entries depicted in FIG. 3B can be stored in look-up table 350 prior to packet forwarding operations performed by switching device 200. For one embodiment, the entries can be stored in protocol table 350 upon connection of each external device to one of the ports of the switching device 200. For example, when Ethernet device ETH_D1 is connected to Ethernet port ETH1, an entry (e.g., entry 353) including the MAC address of device ETH_D1, the port ID of ETH1, and the protocol type of port ETH1 can be stored in table 350. In this manner, if the destination address and/or other routing information associated with a received packet is not stored in the forwarding table 300 of the FIB 230, the forwarding engine 220 can access protocol entries in table 350 to determine the protocol type of the originating port, and in response thereto select the appropriate type of packet flooding mechanism to ensure that the packet reaches its destination without creating unnecessary data loops within the switching device 200.

For some embodiments, when the forwarding engine 220 first receives a packet having particular a source MAC address via one of its ports, the forwarding engine 220 can associate that port with the source MAC address by entering an entry in the protocol table 350, thereby “learning” the MAC addresses associated with the port. Thereafter, when the forwarding engine 220 subsequently receives another packet having a destination MAC address already stored in the FIB 230, the forwarding engine 220 forwards the packet to the port associated with the corresponding MAC address.

Further, for some embodiments, the forwarding table 300 and protocol table 350 can be implemented as separate, independently searchable tables within the FIB 230, for example, as depicted in FIGS. 3A and 3B. In this manner, the forwarding engine 220 may first search the forwarding table 300 to determine whether forwarding information for the packet is stored in the FIB 230, and if not, then search the protocol table 350 to determine which packet flooding operation to employ in response to the type of the communication protocol employed by the originating port and/or source device. For other embodiments, the entries of forwarding table 300 and the entries of protocol table 350 can be implemented as single searchable table within the FIB 230.

FIG. 3C shows an exemplary embodiment of another protocol look-up table 360 that can be provided within the FIB 230 of FIG. 2. Look-up table 360, which is similar to and includes all of the fields of look-up table 350 of FIG. 3B except for the protocol type field, includes an additional field to store flood behavior information for each entry. For the exemplary embodiment shown in FIG. 3C, entries 351 and 352 of table 360 each store a flood behavior value of “ALL” to indicate that during packet flooding operations, forwarding engine 220 is to flood the packet to all ports including the originating port. Each of entries 353-356 of table 360 stores a flood behavior value of “NORMAL” to indicate that during packet flooding operations, forwarding engine 220 floods the packet to all ports except the originating port.

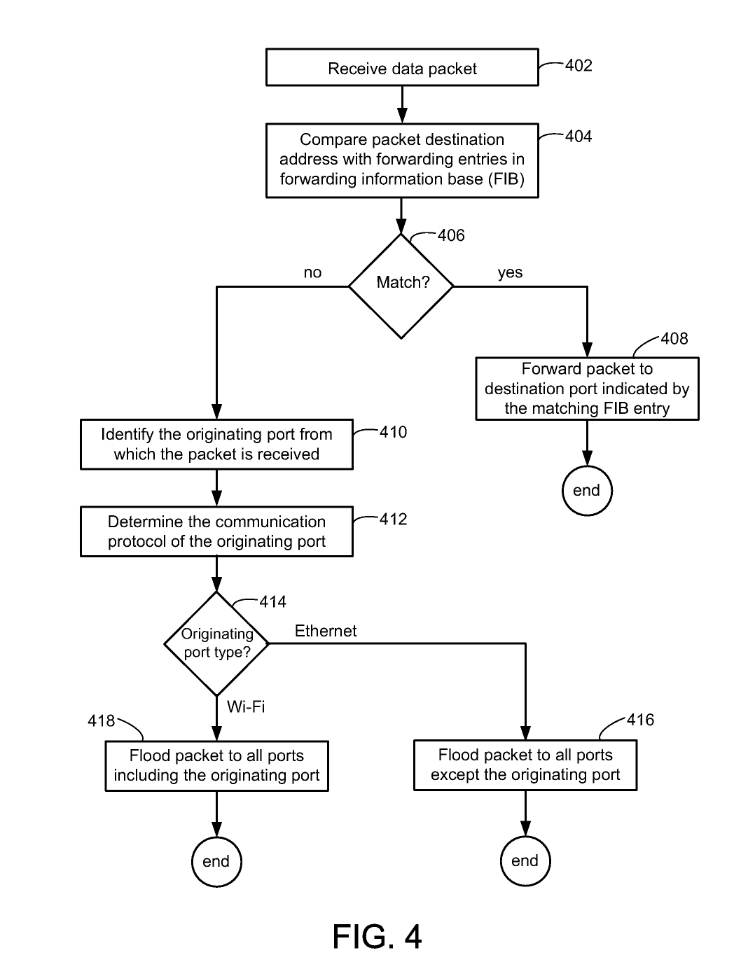

An exemplary operation for forwarding a data packet through switching device 200 is described below with respect to the illustrative flow chart of FIG. 4. First, switching device 200 receives a data packet from an external device or source (402). The packet may be received from Wi-Fi devices WF_D1 or WF_D2 via Wi-Fi port SSID1, from one of Ethernet devices ETH_D1-ETH_D4 via respective Ethernet ports ETH1-ETH4, or from another device via link 201. Then, the forwarding engine 220 extracts destination address information from the packet's header, and compares the destination address information with forwarding entries stored in the forwarding table 300 of the FIB 230 to determine whether a matching entry is stored therein (406). If there is a matching entry stored in the FIB 230, as tested at 406, then the forwarding information associated with the matching entry is obtained, and the forwarding engine 220 forwards the packet to the destination port of switching device 200 as indicated by the obtained forwarding information (408). Thereafter, the packet can be routed to its destination address in a well-known manner.

Conversely, if there is not a matching entry in the forwarding table 300 of the FIB 230, as tested at 406, which may indicate that the data packet is destined for a network address that has not previously been seen by switching device 200, then the forwarding engine 220 identifies the originating port from which the packet is received (410), and determines the communication protocol of the originating port (412). Referring also to FIGS. 2 and 3B, for some embodiments, the forwarding engine 220 extracts the source port number from the packet header and compares the extracted source port number with the port protocol entries stored in the protocol table 350 of the FIB 230 to determine the communication protocol of the originating port. Once the matching entry from the protocol table 350 is accessed, the protocol ID portion of the matching entry is examined and used to indicate the communication protocol of the originating port. For one example, if the source port number extracted from the packet header is “SSID1,” then a search of protocol table 350 will generate a match with entries 351 and 352, both of which indicating that the originating port is a Wi-Fi port. For another example, if the source port number extracted from the packet header is “ETH2,” then a search of protocol table 350 will generate a match with entry 354 indicating that the originating port is an Ethernet port.

For other embodiments, the device ID (e.g., the MAC address) of the originating client device can be extracted from the packet header and used as a search key for searching the protocol entries stored in the protocol table 350. For one example, if the device ID extracted from the packet header is “MAC1,” then a search of protocol table 350 will generate a match with entry 351 indicating that the originating port is a Wi-Fi port. For another example, if the device ID extracted from the packet header is “MAC4,” then a search of protocol table 350 will generate a match with entry 354 indicating that the originating port is an Ethernet port.

Referring again to FIG. 4, if the originating port is an Ethernet port, as tested at 414, then the forwarding engine 220 floods the packet to all ports except the originating port (416). This “split-horizon” packet flooding technique ensures that the packet reaches its intended destination without creating any unnecessary data loops within the switching device 200. For example, if the packet originated from Ethernet device ETH_D4 via Ethernet port ETH4, then the packet's destination may be a device attached to any port except Ethernet port ETH4, and therefore it is unnecessary to flood the packet back to the originating device.

Conversely, if the originating port is a Wi-Fi (or Bluetooth or other type of wireless communication) port, as tested at 414, then the forwarding engine 220 floods the packet to all ports including the originating port (418). This modified flooding operation ensures that the packet reaches its intended destination even if both the source and destination devices are coupled to the same port of switching device 200. For example, if the packet originated from Wi-Fi device WF_D1 via Wi-Fi port SSID1 and is destined for Wi-Fi device WF_D2 (which is also coupled to Wi-Fi port SSID1), then the packet will reach its intended destination only if the forwarding engine 220 floods the packet back to the same port from which the packet is received (e.g., to Wi-Fi port SSID1). For some embodiments, this modified flooding operation can be utilized when the source and destination devices are coupled to the same port of the switching device 200 but communicate according to different wireless standards (e.g., where the source device is a Wi-Fi enabled device and the destination device is a Bluetooth-enabled device).

For some embodiments, this modified flooding operation can be utilized when the source and destination devices are coupled to the same port of the switching device 200 but communicate according to different “flooding indications.”

For still other embodiments, the forwarding engine 220 can search table 360 of FIG. 3C to identify which type of flooding behavior to apply to the incoming packet, at step 410. For example, if the looked-up flooding behavior is “FULL,” then the forwarding engine 220 floods the packet to all ports including the originating port (418). Conversely, if the looked-up flooding behavior is “NORMAL,” then the forwarding engine 220 floods the packet to all ports except the originating port (416).

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. For example, method steps depicted in the flow chart of FIG. 4 can be performed in other suitable orders and/or one or more methods steps may be omitted.

The present embodiments may be provided as a computer program product, or software, that may include a machine-readable medium having stored thereon instructions. The machine readable medium may be used to program a computer system (or other electronic devices) to generate articles (e.g., wafer masks) used to manufacture the present embodiments. The machine-readable medium may include, but is not limited to, optical disks, CD-ROMs, and magneto-optical disks, ROMs, RAMs, EPROMs, EEPROMs, magnet or optical cards, flash memory, or other type of media/machine-readable medium suitable for storing electronic instructions and/or data.

The machine readable medium may store data representing an integrated circuit design layout that includes the present embodiments. The design layout for the integrated circuit die may be generated using various means, for examples, schematics, text files, gate-level netlists, hardware description languages, layout files, etc. The design layout may be converted into mask layers for fabrication of wafers containing one or more integrated circuit dies. The integrated circuit dies may then be assembled into packaged components. Design layout, mask layer generation, and the fabrication and packaging of integrated circuit dies are known in the art; accordingly, a detailed discussion is not provided.

What is claimed is:

1. A network switching device supporting multiple communication protocols, comprising:
a first port operating according to a wireless communication protocol and coupled to a plurality of first client devices;
a plurality of second ports each operating according to a wired communication protocol and each coupled to a corresponding one of a plurality of second client devices;
a forwarding information base (FIB) including a first look-up table having a plurality of entries, each entry including a device identifier identifying a corresponding one of the client devices, a port identifier identifying the port coupled to the corresponding client device, and a protocol identifier indicating the communication protocol of the port coupled to the corresponding client device; and
a forwarding engine, coupled to the first port, the second ports, and the FIB, to receive a data packet from one of the client devices and to identify the communication protocol of the port from which the data packet originated.

2. The network switching device of claim 1, wherein the FIB includes a single look-up table that stores forwarding information and communication protocol information for both the first port and the second ports.

3. The network switching device of claim 1, wherein the wireless communication protocol comprises Wi-Fi communications, and the wired communication protocol comprises Ethernet communications.

4. The network switching device of claim 1, wherein the forwarding engine is to compare a source device identifier extracted from a header of the data packet with entries stored in the FIB to determine whether the data packet originated from the first port operating according to the wireless communication protocol.

5. The network switching device of claim 1, wherein the forwarding engine is to compare a source port identifier extracted from a header of the data packet with entries stored in the FIB to determine whether the data packet originated from the first port operating according to the wireless communication protocol.

6. The network switching device of claim 1, wherein the forwarding engine is to extract the port identifier from a header of the data packet to determine whether the data packet originated from the first port operating according to the wireless communication protocol.

7. The network switching device of claim 6, wherein the forwarding engine is to insert the protocol identifier into a header of the data packet.

8. The network switching device of claim 7, wherein ingress circuitry is to insert the protocol identifier into the packet header.

9. The network switching device of claim 1, wherein if a destination address of the data packet does not match any destination addresses stored in the FIB, then:
the forwarding engine is to flood the data packet to all ports except the originating port if one of the second ports is the originating port; and
the forwarding engine is to flood the data packet to all ports including the originating port if the first port is the originating port.

10. The network switching device of claim 1, wherein the forwarding engine is implemented entirely using hardware components.

11. A network switching device supporting multiple communication protocols, comprising:
a Wi-Fi port coupled to a plurality of first client devices;
a plurality of Ethernet ports each coupled to a corresponding one of a plurality of second client devices; and
a forwarding engine, coupled to the first and second ports, to receive a data packet from a client device via an originating port and configured to:
flood the data packet to all ports except the originating port if one of the Ethernet ports is the originating port; and
flood the data packet to all ports including the originating port if the Wi-Fi port is the originating port.

12. The network switching device of claim 11, wherein the forwarding engine is implemented entirely using hardware components.

13. The network switching device of claim 11, further comprising:
a forwarding information base (FIB) having a plurality of entries, each entry including a device identifier identifying a corresponding one of the client devices and including a protocol identifier indicating whether the port coupled to the corresponding client device operates according to Wi-Fi communication protocols or Ethernet communication protocols.

14. The network switching device of claim 13, wherein the FIB includes a single look-up table that stores forwarding information for both the Wi-Fi port and the Ethernet ports.

15. The network switching device of claim 13, wherein each entry further includes a port identifier identifying the port coupled to the corresponding client device.

16. The network switching device of claim 13, wherein the forwarding engine is to compare a source address of the data packet with the entries stored in the FIB to identify the communication protocol of the originating port.

17. In a network switching device having a Wi-Fi port coupled to a number of first client devices and having a plurality of Ethernet ports each coupled to a corresponding one of a plurality of second client devices, a method of forwarding a data packet through the switching device, comprising:
identifying an originating port from which the data packet is received;
determining whether a destination address of the data packet is stored in a forwarding information base (FIB) provided within the switching device; and
if the destination address does not match any entries stored in the FIB,
flooding the data packet to all ports except the originating port if the originating port is one of the Ethernet ports; and
flooding the data packet to all ports including the originating port if the originating port is the Wi-Fi port.

18. The method of claim 17, wherein the FIB includes a single look-up table that stores forwarding information for both the Wi-Fi port and the Ethernet ports.

19. The method of claim 17, wherein the FIB comprises:
a plurality of entries, each entry including a device identifier identifying a corresponding one of the client devices and including a protocol identifier indicating whether the port coupled to the corresponding client device is the Wi-Fi port or one of the Ethernet ports.

20. The method of claim 19, wherein the identifying comprises:
comparing a source address of the data packet with the plurality of entries; and
extracting the protocol identifier of a matching entry to determine whether the originating port is the Wi-Fi port or one of the Ethernet ports.

21. The method of claim 19, wherein the identifying comprises:
comparing a device ID of the originating client device with the plurality of entries; and
extracting the protocol identifier of a matching entry to determine whether the originating port is the Wi-Fi port or one of the Ethernet ports.

22. The method of claim 17, further comprising:
storing the plurality of entries in the FIB prior to receiving the data packet.
